(19) United States
(12) Patent Application Publication
(10) Pub. No.: US 2011/0246291 A1
(43) Pub. Date: Oct. 6, 2011

(54) COMPUTER SYSTEM AND METHODS OF DYNAMIC PRODUCT CONTENT DISPLAY AND SYNCHRONIZED DISTRIBUTED PROGRAMMING

(76) Inventor: Lonny Paul, Miami, FL (US)

(21) Appl. No.: 13/078,818

(22) Filed: Apr. 1, 2011

Related U.S. Application Data
(60) Provisional application No. 61/319,956, filed on Apr. 1, 2010.

(51) Int. Cl. G06Q 30/00

(52) U.S. Cl. 705/14.49

(57) ABSTRACT

In one embodiment, the instant invention includes a computer-implemented method having steps of: a) providing a product database of products sold in at least one physical retail store; b) dynamically generating an on-screen layout for at least one electronic product displayed in a physical retail store, having: 1) product specification, 2) price, 3) product availability, 4) content related to the electronic product, 5) at least one recommendation to buy at least one other product, 6) electronic tools, and 7) a code that can be electronically communicated from the on-screen layout to an electronic device of a customer in the physical retail store; c) receiving input corresponding to the customer's interaction with the on-screen layout; and d) dynamically modifying at least one of the following: 1) the data in the product database, 2) the on-screen layout, and 3) information in the electronic device of the customer.

### RELATED APPLICATIONS

This application claims the benefit of U.S. provisional application Ser. No. 61/319,956 filed Apr. 1, 2010, entitled “COMPUTER SYSTEM AND METHODS OF DYNAMIC PRODUCT CONTENT DISPLAY AND SYNCHRONIZED DISTRIBUTED PROGRAMMING,” which is hereby incorporated by reference herein in its entirety for all purposes.

### TECHNICAL FIELD

The present invention relates to operation of a physical retail store.

### BACKGROUND

It is typical, for certain electronic products (such as computers, laptops, TV, etc.) which are on a display in a physical retail store to show images.

### SUMMARY OF INVENTION

In some embodiments, the instant invention includes a computer-implemented method that includes steps of: a) providing, by a computer system, at least one product database of products sold in at least one physical retail store, wherein the at least one product database stores data comprising: 1) product specification data, 2) product price data, and 3) product inventory data; b) dynamically generating, by a computer system, an on-screen layout for at least one electronic product displayed in the at least one physical retail store, wherein the on-screen layout, comprising: 1) at least a portion of the product specification data for the at least one electronic product displayed in the at least one physical retail store, 2) a price for the at least one electronic product displayed in the at least one physical retail store, wherein the price is based, at least in part, on the product price data, 3) product availability information for the at least one electronic product displayed in the at least one physical retail store, wherein the product availability information is based, at least in part, on the product inventory data of a particular physical retail store where the at least one electronic product is displayed, 4) content data related to the at least one electronic product, wherein the content data is dynamically generated from non-specification information of the at least one electronic product displayed in the at least one physical retail store, wherein the content data is associated with the at least one electronic product based, at least in part, on the product specification data of the at least one electronic product, 5) at least one recommendation to buy at least one other product sold by the at least one physical retail store, wherein the at least one recommendation is based, at least in part, on the product inventory data of the at least one physical retail store, 6) at least one tool which allows a customer to electronically perform at least one of the following action: i) view the content data related to the at least one electronic product, ii) place an order to purchase at least one product offered by the at least one physical retail store, iii) share with at least one other person at least a portion of the information provided by the on-screen layout, and iv) access information located outside of the at least one physical retail store, and 7) at least one code that can be electronically communicated from the on-screen layout of the at least one electronic product displayed in the at least one physical retail store to an electronic device of the customer located in the at least one physical retail store, wherein the electronic device of the customer uses the at least one code to electronically obtain at least a portion of the information provided by the on-screen layout; c) receiving, by a computer system, at least one input corresponding to the customer's interaction with the on-screen layout of the at least one electronic product displayed in the at least one physical retail store; and d) dynamically modifying, by a computer system, in response to the at least one input corresponding to the customer's interaction with the on-screen layout of the at least one electronic product displayed in the at least one physical retail store, at least one of the following: 1) the data in the at least one product database of electronic products sold in at least one physical retail store, 2) the on-screen layout of the at least one electronic product displayed in the at least one physical retail store, and 3) the at least a portion of the information provided by the on-screen layout in the electronic device of the customer.

In some embodiments, the at least one code is electronically communicated from the on-screen layout of the at least one electronic product displayed in the at least one physical retail store to the electronic device of the customer located in the at least one physical retail store, when the electronic device of the customer electronically acquires an image of the at least one code.

In some embodiments, the image represents a UPC code or a QR code.

In some embodiments, the at least one code is electronically communicated from the on-screen layout of the at least one electronic product displayed in the at least one physical retail store to the electronic device of the customer located in the at least one physical retail store, when the electronic device of the customer wirelessly acquires a data encoded by the at least one code from the at least one electronic product displaying the on-screen layout.

In some embodiments, the at least one recommendation to buy at least one other product sold by the at least one physical retail store is dynamically generated, by a computer system, based at least in part, on: 1) at least one assigned criteria, and 2) statistically applicable products.

In some embodiments, the at least one recommended product is at least one extended warranty offer.

In some embodiments, the product availability information for the at least one electronic product displayed in the at least one physical retail store is electronically updated based on a geographical location of the particular physical retail store.

In some embodiments, the content data comprising at least one of the following: 1) warranty information, 2) at least one product review, and 3) educational information.

In some embodiments, the on-screen layout is divided into tabs.

In some embodiments, the instant invention includes a computer system for operating electronic products in a physical retail store which includes: i) memory having at least one region for storing computer executable program code; and ii) a processor for executing the program code stored in the memory, wherein the program code comprising: a) software code to provide at least one product database of products sold in at least one physical retail store, wherein the at least one product database stores data comprising: 1) product specification data, 2) product price data, and 3) product inventory data; b) software code to dynamically generate an on-screen layout for at least one electronic product displayed in the at least one physical retail store, wherein the on-screen layout, comprising: 1) at least a portion of the product specification data for the at least one electronic product displayed in the at least one physical retail store, 2) a price for the at least one electronic product displayed in the at least one physical retail store, wherein the price is based, at least in part, on the product price data, 3) product availability information for the at least one electronic product displayed in the at least one physical retail store, wherein the product availability information is based, at least in part, on the product inventory data of a particular physical retail store where the at least one electronic product is displayed, 4) content data related to the at least one electronic product, wherein the content data is dynamically generated from non-specification information of the at least one electronic product displayed in the at least one physical retail store, wherein the content data is associated with the at least one electronic product based, at least in part, on the product specification data of the at least one electronic product, 5) at least one recommendation to buy at least one other product sold by the at least one physical retail store, wherein the at least one recommendation is based, at least in part, on the product inventory data of the at least one physical retail store, 6) at least one tool which allows a customer to electronically perform at least one of the following action: i) view the content data related to the at least one electronic product, ii) place an order to purchase at least one product offered by the at least one physical retail store, iii) share with at least one other person at least a portion of the information provided by the on-screen layout, and iv) access information located outside of the at least one physical retail store; and 7) at least one code that can be electronically communicated from the on-screen layout of the at least one electronic product displayed in the at least one physical retail store to an electronic device of the customer located in the at least one physical retail store, wherein the electronic device of the customer uses the at least one code to electronically obtain at least a portion of the information provided by the on-screen layout; c) software code to receive at least one input corresponding to the customer's interaction with the on-screen layout of the at least one electronic product displayed in the at least one physical retail store; and d) software code to dynamically modify, in response to the at least one input corresponding to the customer's interaction with the on-screen layout of the at least one electronic product displayed in the at least one physical retail store, at least one of the following: 1) the data in the at least one product database of electronic products sold in at least one physical retail store, 2) the on-screen layout of the at least one electronic product displayed in the at least one physical retail store, and 3) the at least a portion of the information provided by the on-screen layout in the electronic device of the customer.

### BRIEF DESCRIPTION OF THE DRAWINGS

FIG. 1 illustrates an embodiment of the present invention.

FIG. 2 illustrates another embodiment of the present invention.

FIG. 3 illustrates yet another embodiment of the present invention.

FIG. 4 illustrates yet another embodiment of the present invention.

FIG. 5 illustrates yet another embodiment of the present invention.

FIG. 6 illustrates yet another embodiment of the present invention.

FIG. 7 illustrates yet another embodiment of the present invention.

FIG. 8 illustrates yet another embodiment of the present invention.

FIG. 9 illustrates yet another embodiment of the present invention.

FIG. 10 illustrates yet another embodiment of the present invention.

FIG. 11 illustrates yet another embodiment of the present invention.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

### DETAILED DESCRIPTION

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

For purposes of this disclosure, the term “product” means any physical item, any intangible item (e.g, software without a physical medium), and/or any service (e.g., warranty, etc.) which can be offered or sold by a physical retail store.

In some embodiments, the inventive computer system and methods may allow for displaying a dynamic content at a point-of-sale (POS) through a single electronic device sold at a retail store with whom potential purchasers may interact while shopping at the store.

In some embodiments, the inventive computer system and methods may provide an on-screen layout for user interface on any-size display (touch and/or manual interfaces) of any electronic device in the store.

In some embodiments, the inventive computer system and methods may provide an on-screen layout for user interface on any-size display by automatically sensing a display size or any other functional characteristic of the displayed product that can affect the operation and/or visual presentation of the on-screen layout and, consequently, adopting the on-screen layout performance based at least in part on those functional characteristics.

In some embodiments, the inventive computer system and methods may provide on-screen layout which may include a product name.

In some embodiments, the inventive computer system and methods may provide an on-screen layout which may include photo gallery, primary view image (from multiple images, rotating based on idle time or user interface).

In some embodiments, the inventive computer system and methods may provide an on-screen layout which may include photo gallery “coming up” image preview. In some embodiments, the inventive computer system and methods may provide on-screen layout which may include photo gallery “last image” image review.

In some embodiments, the inventive computer system and methods may provide an on-screen layout which may include a manufacturer name. In some embodiments, the inventive computer system and methods may provide on-screen layout which may include price, including “list/msrp/comparison price and/or savings.”

In some embodiments, the inventive computer system and methods may provide an on-screen layout which may include dynamically generated QR code to point to either promotional offer or content via mobile device portable of scanning standardized 2D QR code or other code formats. A QR Code (“Quick Response”) is a matrix code (or two-dimensional bar code), which allow for its contents to be decoded at high speed. In some embodiments, QR codes store addresses and URLs. In some embodiments, shoppers with a camera phone equipped with the correct reader software may scan the image of the QR Code displayed through an electronic device by the inventive computer system causing the phone's browser to launch and redirect to the programmed URL. This act of linking from physical world objects is known as a hardlink or physical world hyperlinks. For example, Google's mobile Android operating system supports the use of QR codes by natively including the barcode scanner (ZXing) on some models and the browser supports URI redirection, which allows QR Codes to send metadata to existing applications on the device. Another example, Nokia's symbian operating system is also provided with a barcode scanner, which is able to read QR Codes.

In some embodiments, the inventive computer system and methods may provide an on-screen layout which may include a specification table, allowing shoppers to select to read standard specifications for product (default).

In some embodiments, the inventive computer system and methods may provide an on-screen layout which may include a description tab, allowing shoppers to select to read overview of product information

In some embodiments, the inventive computer system and methods may provide an on-screen layout which may include a customer review tab, allowing shoppers to select to read other customer reviews and 5 star rating.

In some embodiments, the inventive computer system and methods may provide an on-screen layout which may include dynamic product content, specifications and/or user reviews based upon central database augmented with educational information intended for specific sub-set of product selection.

In some embodiments, the inventive computer system and methods may provide an on-screen layout which may include a integrated listing of product warranty terms and optionally extended service offerings.

In some embodiments, the inventive computer system and methods may provide an on-screen layout which may provide shoppers with an integrated capability to ‘share’ product via social networking or other api enabled applications. In some embodiments, the inventive computer system and methods may provide an on-screen layout which may allow shoppers to send a product description link (with or without price) to their Facebook or Twitter accounts.

In some embodiments, the inventive computer system and methods may provide an on-screen layout which may include an integrated service sales link to launch a product selection and ordering tool. In some other embodiments, the selection and ordering tool is user-configurable.

In some embodiments, the inventive computer system and methods may provide an on-screen layout which may include a customer facing SKU number or an internal product id code for reference.

In some embodiments, the inventive computer system and methods may provide an on-screen layout which may include a primary tab with a configurable functionality having, as its default function, a pointer (direction) to product web page.

In some embodiments, the inventive computer system and methods may provide an on-screen layout which may include a secondary tab with a configurable functionality having, as its default function, at least one of the following features:

1) recommending products to compliment the purchase of the product on display,

2) choosing from either a default pool of defined item or utilizing product-specific data of assigned or statistically applicable products; and

3) launching full-screen video when present on the displayed product.

In some embodiments, the inventive computer system and methods may provide an on-screen layout which may include a third tab with a configurable functionality having, as its default function, a feature of providing relevant educational data.

In some embodiments, the inventive computer system and methods may provide an on-screen layout which may include a fourth tab with a configurable functionality having, as its default function, a feature of providing relevant sales tools.

In some embodiments, the inventive computer system and methods may utilize devices that can communicate via IEEE 802.11b, a wireless networking standard. For example, a retail store may sell a digital camera with an IEEE 802.11b transmitter and a printer incorporating wireless chipsets.

In some embodiments, the inventive computer system and methods may utilize devices with technologies such as NetSense, UPnP, iReady, Bluetooth as a communication medium.

In one embodiment, a system comprises a host application executing on, for example, a retail store's server, and one or more networked devices (wireless and/or wired network) executing a client application. A networked device can include any capable electronic device such as a consumer appliance equipped with network capability, a digital device such as MP3 players and DVRs, an electronically-controlled device such as a light circuit or other type of circuit, and the like.

In some embodiments, the host application automatically establishes communication with the networked device. First, the networked device can automatically access a network (e.g., a wireless network having a DHCP service) on which it can broadcast a network address and service. The host application can sense the broadcast and automatically establish communication with the network appliance while registering the service.

In another embodiment, the networked device dynamically configures a user interface for user control of the networked device. To do so, the networked device can transmit user interface information that specifies components of a user interface. The user interface information can be structured in an open format. The components are related to application level control of the service provided by the network appliance. For example, the networked device can use XML to format name-value pairs, i.e., names of components and current values associated with the components. The host then generates the user interface from a component repository and sets values as indicated by the networked device.

In some embodiments, the user interface can also display components related to lower level control such as an information about the networked device (e.g., on, off, online, offline, error, product category, UPC, and the like); communications configuration (e.g., IP address, port, network connection, and the like); position intelligence (e.g., data from Global positioning system (GPS), position on a floor plan, etc.) and/or location intelligence (neighboring networked/non-networked device(s)).

In yet another embodiment, the host application can provide a graphical layout of the networked device. Accordingly, the host application can display a floor plan or pictures of the environment containing the networked device (e.g., pictures of a showroom). In some embodiments, the on-screen layout/interface has a consistent and recognizable format across different networked devices, but is nevertheless customized to capabilities of the networked device.

In some embodiments, while in a physical retail store, customers' electronic devices (e.g., PDAs, smart phones, iPADs, etc.) acquire data communicated by codes embedded in the on-screen layouts of electronic products displayed in the store, by using any suitable means, such as wireless technology (e.g., WiMAX, Thunderbolt, LTE, NFC, etc.). WiMAX (Worldwide Interoperability for Microwave Access) is a telecommunications protocol that provides fixed and mobile Internet access.

In some embodiments, the displayed electronic products communicate data encoded in codes (e.g., QR code, UPC code, etc.) on the on-screen layout, by utilizing Near field communications, or NFC, which is a set of short-range wireless technologies, typically requiring a distance of 4 cm or less. NFC operates at 13.56 MHz and at rates ranging from 106 kbit/s to 848 kbit/s. NFC always involves an initiator and a target; the initiator typically actively generates an RF field that can power a passive target.

In some embodiments, the displayed electronic products of the store are initiators and customers' electronic devices are targets. This enables NFC targets to take very simple form factors such as tags, stickers, key fobs, or cards that do not require batteries.

In some embodiments, the displayed electronic products of the store are targets and customers' electronic devices are initiators. In some embodiments, NFC peer-to-peer communication is also possible, where both devices are powered.

In some embodiments, NFC can be an open platform technology standardized in, for instance, ECMA-340 and ISO/IEC 18092 standards. These standards specify the modulation schemes, coding, transfer speeds and frame format of the RF interface of NFC devices, as well as initialization schemes and conditions required for data collision-control during initialization for both passive and active NFC modes. Furthermore, they also define the transport protocol, including protocol activation and data-exchange methods.

In some embodiments, customers' electronic device may utilize the CCD (Charge Coupled Device) which is a solid state image pickup device for electro-optically converting the optical image of a code, and the F/E-IC (Front End Integrated Circuit) includes a CDS (Correlation Double Sampling) circuit for performing correlation double sampling used to remove image noise, an AGC (Automatic Gain Control) for performing gain adjusting, an A/D (Analog-to-Digital) converter for performing digital signal conversion, a CCD mechanism which is typically supplied with a vertical synchronization signal (hereinafter, referred to as a VD) and a horizontal synchronization signal (hereinafter, referred to as an SD) from the CCD and controlled by a CPU, and a TG (Timing Generator) for generating a driving timing signal for the F/E-IC.

In some embodiments, for example, a digital still camera displayed in the retail store can include at least one of: a processor, a local flash memory which temporarily stores data needed for on-screen layout, a USB constructs USB communication to an external apparatus such as a customer's or salesperson's PC, a serial block which constructs serial communication to the external apparatus such as the customer's or salesperson's PC, and a memory card slot which can be used to mount a detachable memory card. In addition to the memory card, the memory card slot may be used to mount an IO card such as detachable IAN card, wireless LAN card, and Bluetooth card. The picked-up image can be transmitted to the external apparatus via the IO card.

Illustrative Operating Environments for Operating Electronic Products Displayed in the Retailed Store.

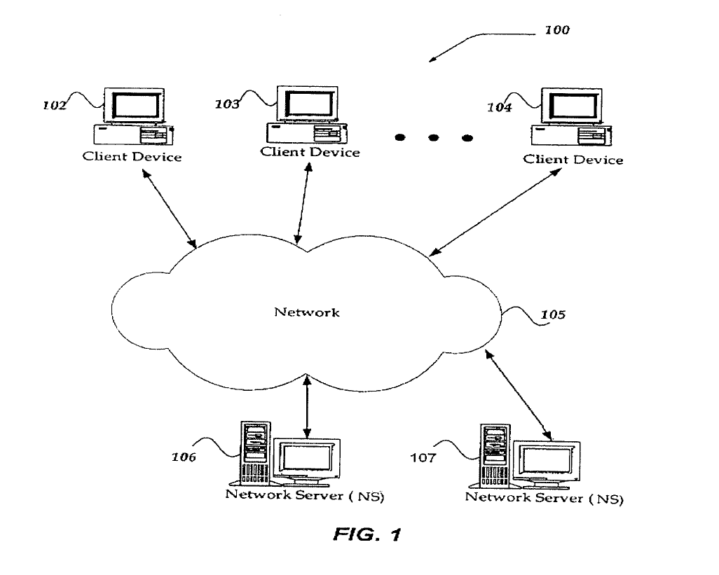

FIG. 1 illustrates one embodiment of an environment in which the present invention may operate. However, not all of these components may be required to practice the invention, and variations in the arrangement and type of the components may be made without departing from the spirit or scope of the invention. In some embodiment, the inventive system hosts a large number of members and concurrent transactions. In other embodiments, the inventive system computer is based on a scalable computer and network architecture that incorporates varies strategies for assessing the data, caching, searching, and database connection pooling. An example of the scalable architecture is an architecture that is capable of operating multiple servers.

In embodiments, client electronic devices 102-104 (electronic devices in the store) include virtually any computing device capable of receiving and sending a message over a network, such as network 105, to and from another computing device, such as servers 106 and 107, each other, and the like. In embodiments, the set of such devices includes devices that typically connect using a wired communications medium such as personal computers, multiprocessor systems, microprocessor-based or programmable consumer electronics, network PCs, and the like. In embodiments, the set of such devices also includes devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, in embodiments, client devices 102-104 are any device that is capable of connecting using a wired or wireless communication medium such as a PDA, POCKET PC, wearable computer, and any other device that is equipped to communicate over a wired and/or wireless communication medium.

In embodiments, each client device within client devices 102-104 includes a browser application that is configured to receive and to send web pages, and the like. In embodiments, the browser application is configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, JavaScript, and the like. In embodiments, the invention is programmed in either Java or .Net.

In embodiments, client devices 102-104 are further configured to receive a message from the another computing device employing another mechanism, including, but not limited to email, Short Message Service (SMS), Multimedia Message Service (MMS), instant messaging (IM), internet relay chat (IRC), mIRC, Jabber, and the like.

In embodiments, network 105 is configured to couple one computing device to another computing device to enable them to communicate. In embodiments, network 105 is enabled to employ any form of computer readable media for communicating information from one electronic device to another. Also, in embodiments, network 105 includes a wireless interface, and/or a wired interface, such as the Internet, in addition to local area networks (LANs), wide area networks (WANs), direct connections, such as through a universal serial bus (USB) port, other forms of computer-readable media, or any combination thereof. In embodiments, on an interconnected set of LANs, including those based on differing architectures and protocols, a router acts as a link between LANs, enabling messages to be sent from one to another.

Also, in some embodiments, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, in embodiments, remote computers and other related electronic devices could be remotely connected to either LANs or WANs via a modem and temporary telephone link. In essence, in embodiments, network 105 includes any communication method by which information may travel between client devices 102-104, and servers 106 and 107.

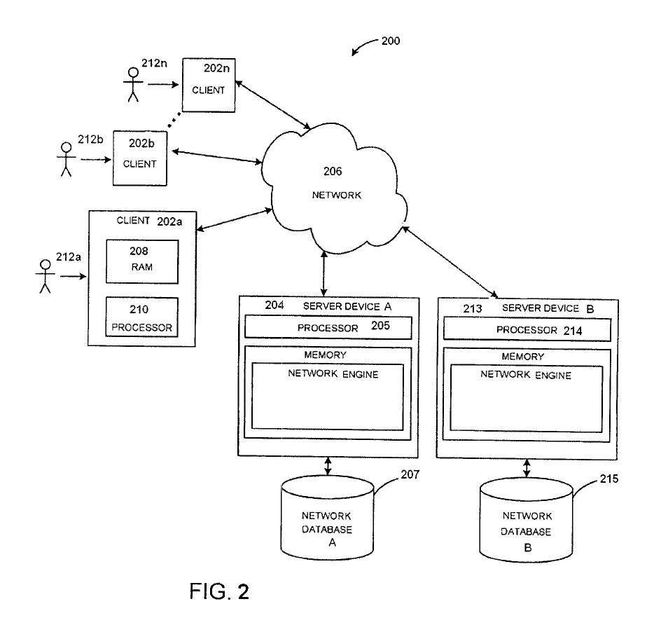

FIG. 2 shows another exemplary embodiment of the computer and network architecture that supports the inventive system. The client devices 202a, 202b thru 202n shown (electronic devices in the store) each comprises a computer-readable medium, such as a random access memory (RAM) 208 coupled to a processor 210 or FLASH memory. The processor 210 executes computer-executable program instructions stored in memory 208. Such processors comprise a microprocessor, an ASIC, and state machines. Such processors comprise, or are be in communication with, media, for example computer-readable media, which stores instructions that, when executed by the processor, cause the processor to perform the steps described herein. Embodiments of computer-readable media include, but are not limited to, an electronic, optical, magnetic, or other storage or transmission device capable of providing a processor, such as the processor 210 of client 202a, with computer-readable instructions. Other examples of suitable media include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media transmit or carry instructions to a computer, including a router, private or public network, or other transmission device or channel, both wired and wireless. The instructions comprise code from any computer-programming language, including, for example, C, C++, C#, Visual Basic, Java, Python, Perl, and JavaScript.

Client devices 202a-n also comprise a number of external or internal devices such as a mouse, a CD-ROM, DVD, a keyboard, a display, or other input or output devices. Examples of client devices 202a-n are personal computers, digital assistants, personal digital assistants, cellular phones, mobile phones, smart phones, pagers, digital tablets, laptop computers, Internet appliances, and other processor-based devices. In general, a client device 202a are be any type of processor-based platform that is connected to a network 206 and that interacts with one or more application programs. Client devices 202a-n operate on any operating system capable of supporting a browser or browser-enabled application, such as Microsoft™, Windows™, or Linux. The client devices 202a-n shown include, for example, personal computers executing a browser application program such as Microsoft Corporation's Internet Explorer™, Apple Computer, Inc.'s Safari™, Mozilla Firefox, and Opera.

Through the client devices 202a-n, users 212a-n communicate over the network 206 with each other and with other systems and devices coupled to the network 206. As shown in FIG. 2, server devices 204 and 213 are also coupled to the network 206.

Of note, the embodiments described herein may, of course, be implemented using any appropriate computer system hardware and/or computer system software. In this regard, those of ordinary skill in the art are well versed in the type of computer hardware that may be used (e.g., a mainframe, a mini-computer, a personal computer (“PC”), a network (e.g., an intranet and/or the internet)), the type of computer programming techniques that may be used (e.g., object oriented programming), and the type of computer programming languages that may be used (e.g., C++, Basic, AJAX, Javascript). The aforementioned examples are, of course, illustrative and not restrictive.

Illustrative Embodiments of the on-Screen Layout of the Instant Invention.

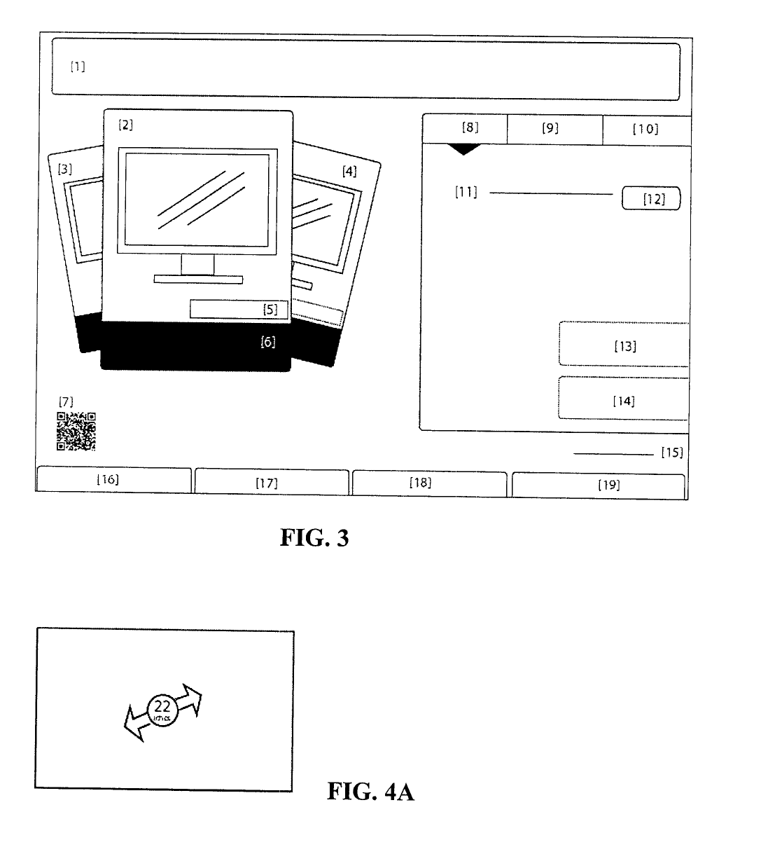

FIG. 3 illustrates one embodiment of the inventive computer system and methods which may provide an on-screen layout that includes:

Item (1) Product name

Item (2) Photo Gallery, Primary View Image (from multiple images, rotating based on idle time or user interface along with #3 and #4)

Item (3) Photo Gallery “Coming Up” Image preview (see #2)

Item (4) Photo Gallery “Last Image” Image review (See #2)

Item (5) Manufacturer Name

Item (6) Price, including “list/msrp/comparison price and/or savings”

Item (7) Dynamically generated QR code to point to either promotional offer or content via mobile device portable of scanning standardized 2D QR code or other code formats

Item (8) Specification table, allows user to select to read standard specifications for product (default)

Item (9) Description tab, allows user to select to read overview of product information

Item (10) Customer Review tab, allow user to select to read other customer reviews and 5 star rating

Item (11) Dynamic product content, specifications and/or user reviews based upon central database augmented with educational information intended for specific sub-set of product selection

Item (12) Integrated listing of product warranty terms and optionally extended service offerings

Item (13) Integrated ability to ‘share’ product via social networking or other API enabled applications

Item (14) Integrated service sales link to launch product selection and ordering tool; configurable;

Item (15) Customer facing SKU or Internal product id code for reference

Item (16) Primary tab, configurable functionality with default function of direction to product web page

Item (17) Secondary tab, configurable functionality with default function of recommending products to compliment the purchase of the product on display, choosing from either a default pool of defined item or utilizing product-specific data of assigned or statistically applicable products; alternatively this tab launches full-screen video when present on the displayed product.

Item (18) Third tab, configurable functionality with default function of providing relevant educational data

Item (19) Fourth tab, configurable functionality with default function of providing relevant sales tools

In some embodiments, the inventive computer system and methods may provide a facility to synchronize the distributed playback a plurality of image data over a plurality of electronic devices in the store.

In some embodiments, the inventive computer system and methods may allow to store information that the inventive computer system may want an electronic device to display in FLASH memory, or any suitable storage faculty, of the electronic device. In some embodiments, the information is store in a cookie (e.g. a FLASH cookie). In some embodiments, storing information instruction locally eliminate a necessity for an electronic device/station to continuous query a server of the inventive computer system, when it is in idle mode. In some embodiments, the stored information is refreshed periodically by the inventive computer system, irrespective of whether the electronic device is in idle mode or not.

In some embodiments, the inventive computer system and methods provide an electronic device with a capability to execute a combined instruction which is based on information from at least one earlier and at least one later-arrived instructions.

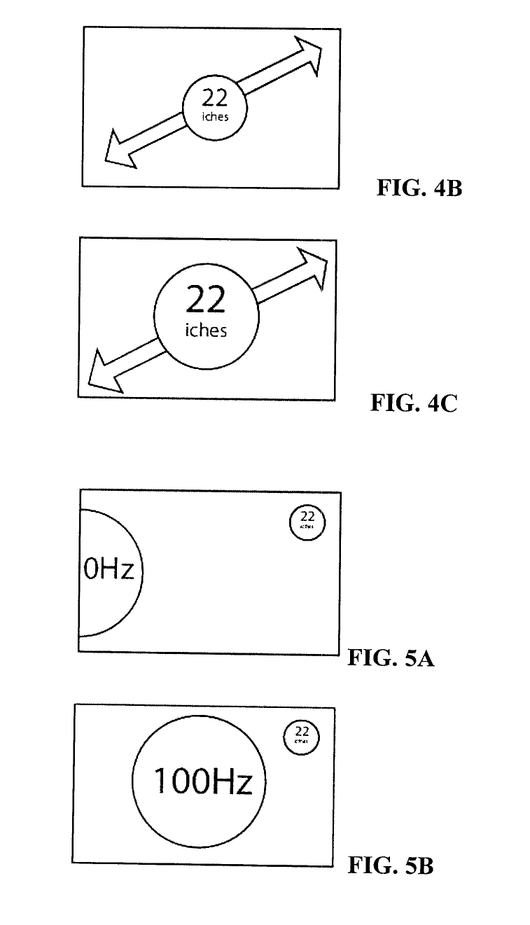

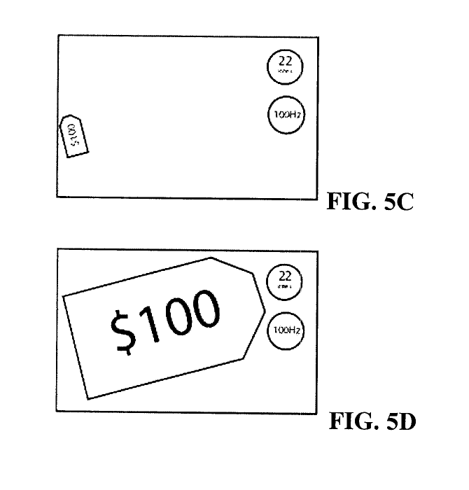

FIGS. 4A-4C and 5A-5D illustrate visual examples that are produced using some embodiments of the inventive computer system and methods to use, for instance, Flash memory to generate dynamic images during idle time of the electronic devices/stations without a need to be continuously refreshed with imaginary and instructions from a centralized database/server.

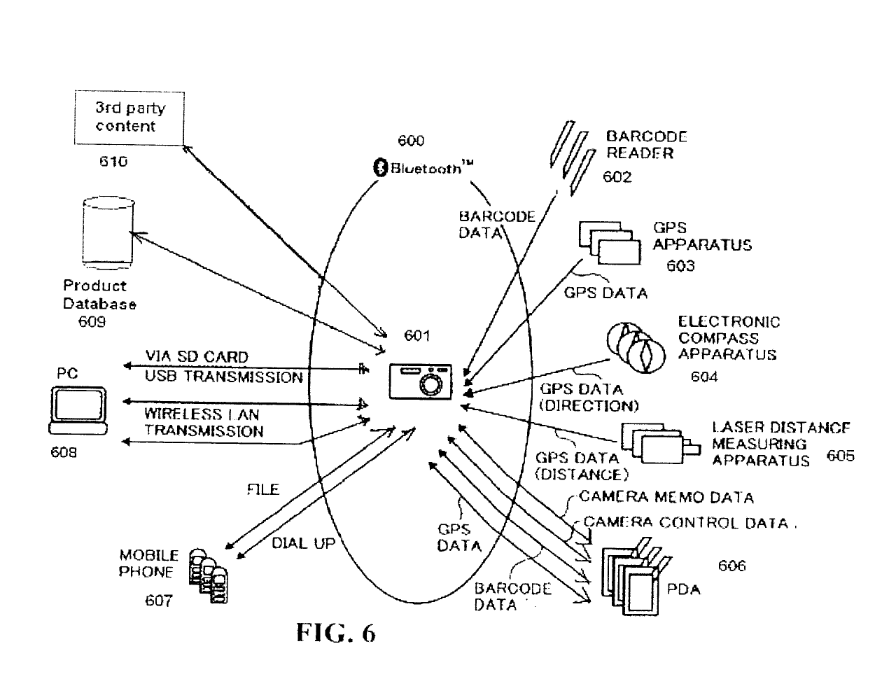

FIG. 6 illustrates a connection diagram for some embodiments of the present invention. FIG. 6 shows an exemplary displayed electronic product sold by the retail store (e.g., camera), showing how the on-screen layout is provided to the displayed electronic product and how information from the on-screen layout is exchanged between the displayed electronic product and an electronic device of a customer. The camera 601 can be connected to a barcode reader 602, GPS (Global Positioning System) apparatus 603, an electronic compass 604, and a laser distance measuring apparatus 605, and a customer's PDA 606 through various Bluetooth profiles 600. In addition, the camera 601 can be connected to a customer's mobile phone 607 and a PC (Personal Computer) 608 through Bluetooth profiles 600 (e.g, object push profile (OPP)). In addition, the camera 601 can be connected to the mobile phone 607 through Bluetooth profiles 600 (e.g, dial-up networking (DUN), etc.). In addition, the camera 601 is connected to at least one product database 609 of the retail store and any 3rd party source 610 from which the displayed device obtains or which can dynamically provide additional product and content data to be displayed by the inventive on-screen layout of the instant invention.

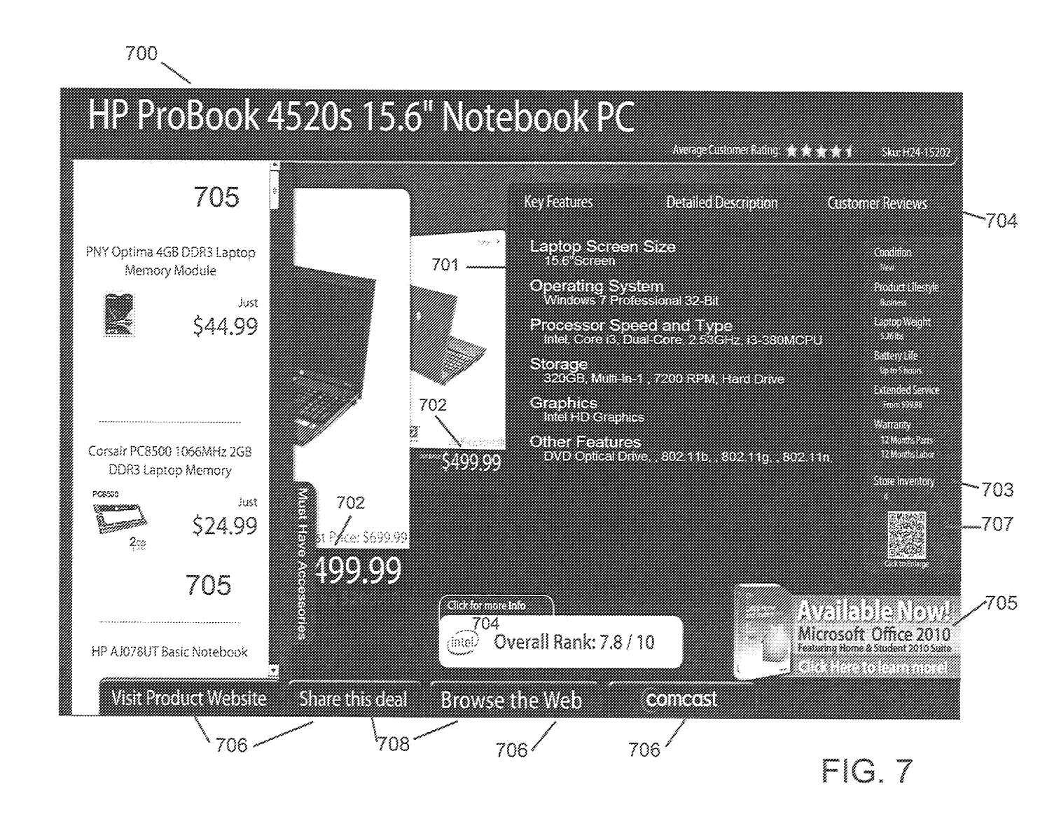

FIG. 7 illustrates one embodiment of the inventive computer system and methods which may provide an on-screen layout (700) that includes:

at least a portion of the product specification data (701) for the at least one electronic product (e.g., HP ProBook) displayed in the at least one physical retail store,

a price for the at least one electronic product displayed in the at least one physical retail store (702), wherein the price is based, at least in part, on the product price data;

product availability information for the at least one electronic product displayed in the at least one physical retail store (703), where the product availability information can be based, at least in part, on the product inventory data of a particular physical retail store where the at least one electronic product is displayed,

content data related to the at least one electronic product (704), where the content data is dynamically generated from non-specification information of the at least one electronic product displayed in the at least one physical retail store, where the content data is associated with the at least one electronic product based, at least in part, on the product specification data of the at least one electronic product,

at least one recommendation (705) to buy at least one other product sold by the at least one physical retail store;

tools (706), shown as tabs (708), which allows a customer to electronically perform at least one of the following action:

i) view the content data related to the at least one electronic product;

ii) place an order to purchase at least one product offered by the at least one physical retail store,

iii) share with at least one other person at least a portion of the information provided by the on-screen layout, and iv) access information located outside of the at least one physical retail store; and

at least one code (707) that can be electronically communicated from the on-screen layout of the at least one electronic product displayed in the at least one physical retail store to an electronic device of the customer located in the at least one physical retail store, where the electronic device of the customer uses the at least one code to electronically obtain at least a portion of the information provided by the on-screen layout.

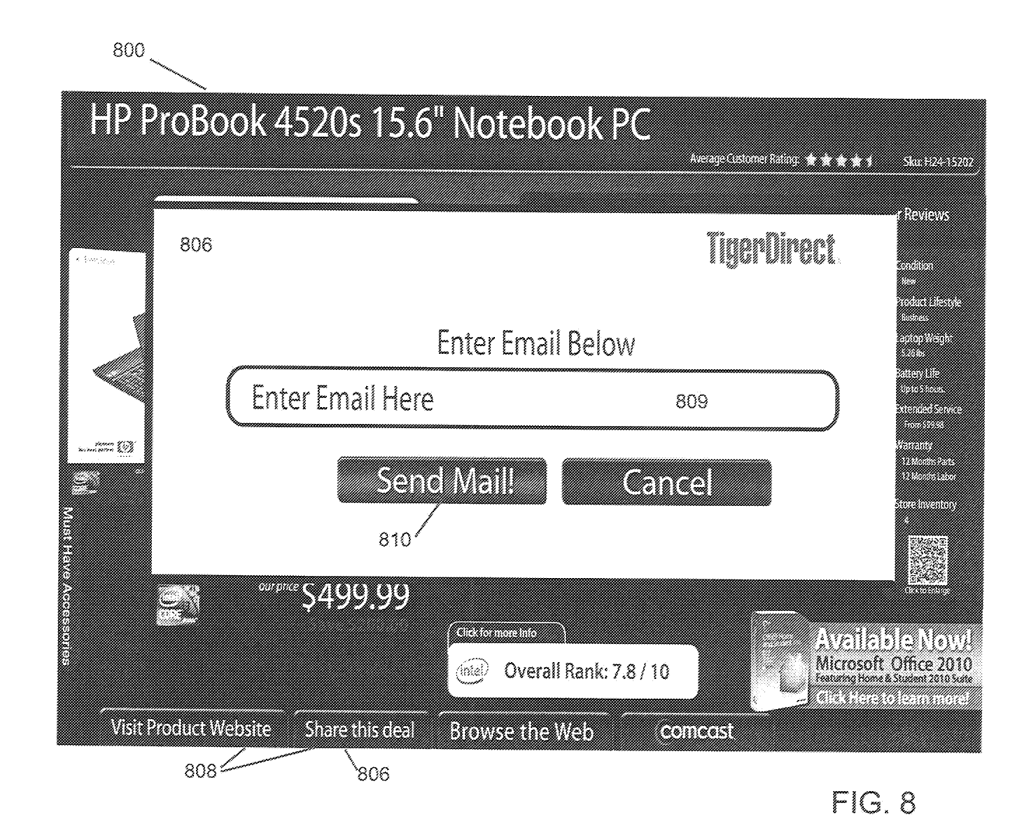

FIG. 8 illustrates one embodiment of the inventive computer system and methods which may provide an on-screen layout (800). Specifically, FIG. 8 illustrates how by clicking on a tab (808) representing a tool “share this deal” (806), the tool “share this deal” (806) is activated and a customer can be prompted to enter his email address or email address (809) of another person to send (810) information shown by the on-screen layout (800).

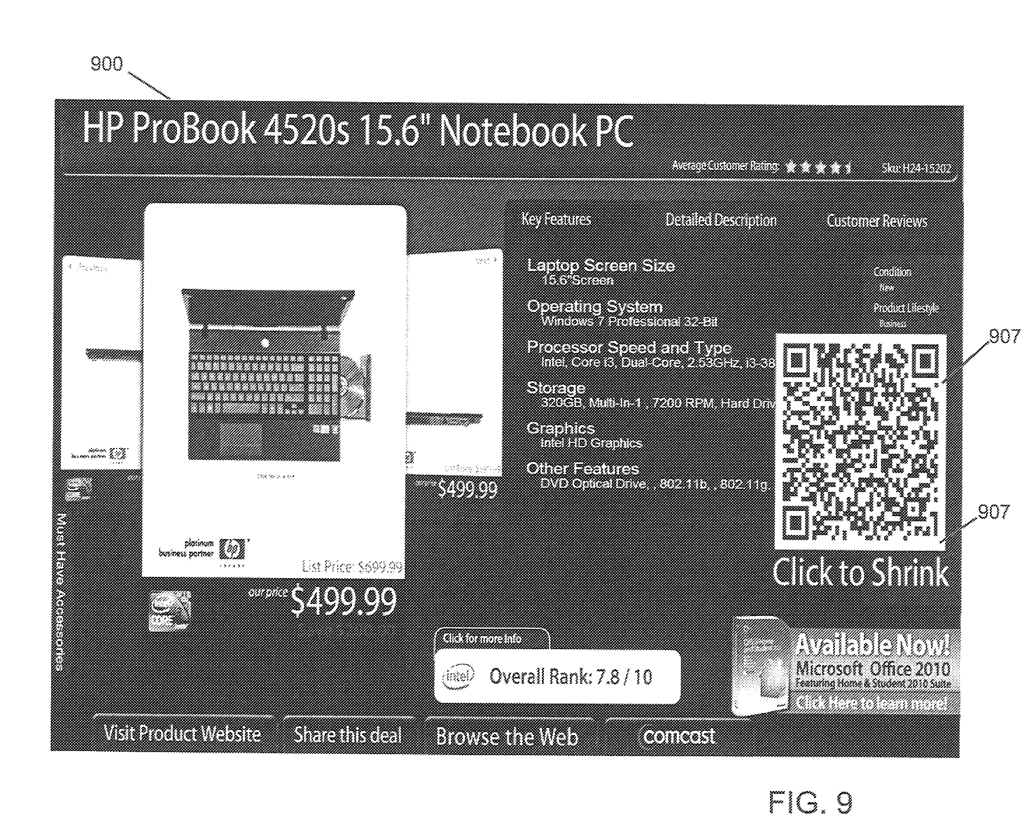

FIG. 9 illustrates one embodiment of the inventive computer system and methods which may provide an on-screen layout (900). Specifically, FIG. 9 illustrates how by clicking on a code (907), a customer can be provided with a magnified version of the code to be communicated to or acquired by the customer's (and/or salesperson's) electronic device.

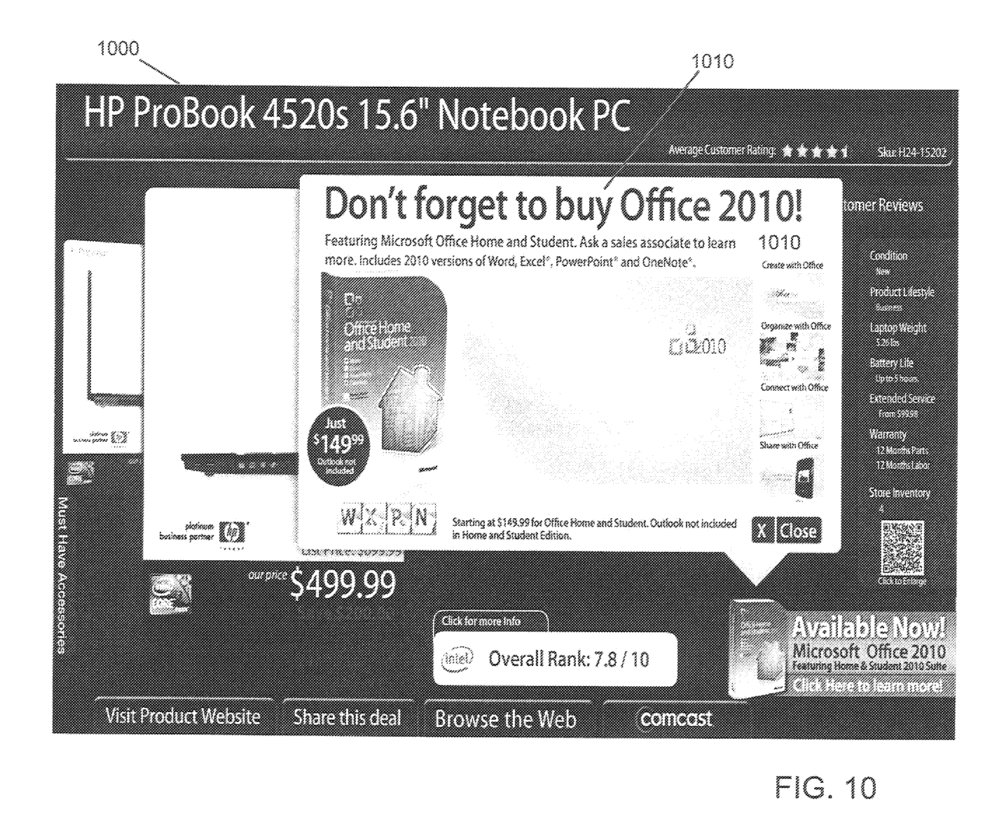

FIG. 10 illustrates one embodiment of the inventive computer system and methods which may provide an on-screen layout (1000). Specifically, FIG. 10 illustrates how the present invention may present additional recommendations in a form of pushed advertisements (1010) while the customer continues to interacts with the electronic product's on-screen layout or remains near (i.e., within a certain distance) the displayed product. In some embodiments, the displayed product received information about a customer's location within the store, including if the same customer still near the displayed product. In some embodiments, the customer's location can be established by the displayed product and/or another device of the retail store by, for example, tracking some identifying characteristic(s) of an electronic device used by the customer, movement/light-blocking sensing device, and/or by measuring a distance using laser distance measuring device.

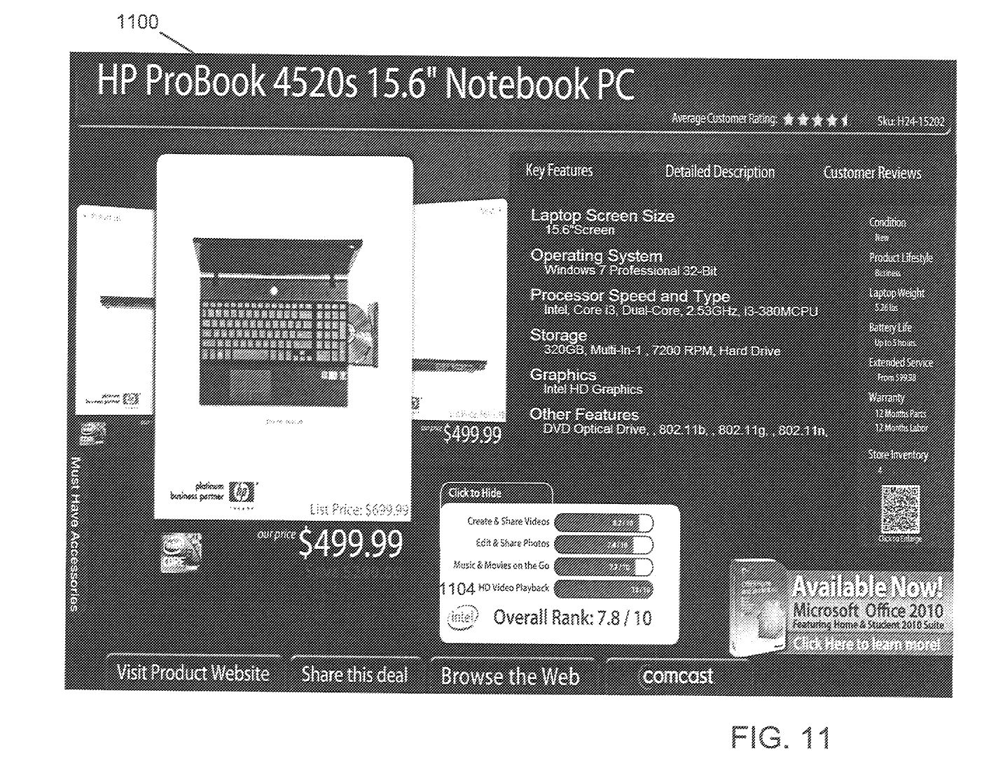

FIG. 11 illustrates one embodiment of the inventive computer system and methods which may provide an on-screen layout (1100). Specifically, FIG. 11 illustrates how the content data related to the at least one electronic product (1104) can include ranking information for the displayed product. In some embodiments, such ranking information (as any other information of the content data) can originate at the retail store (e.g., information collected from customers visited the store or its affiliates (physical and/or on-line) and/or can originate from a 3rd party and be dynamically obtained and/or received by the retail store.

In some embodiments, the instant invention includes a computer-implemented method that includes steps of: a) providing, by a computer system, at least one product database of products sold in at least one physical retail store, wherein the at least one product database stores data comprising: 1) product specification data, 2) product price data, and 3) product inventory data; b) dynamically generating, by a computer system, an on-screen layout for at least one electronic product displayed in the at least one physical retail store, wherein the on-screen layout, comprising: 1) at least a portion of the product specification data for the at least one electronic product displayed in the at least one physical retail store, 2) a price for the at least one electronic product displayed in the at least one physical retail store, wherein the price is based, at least in part, on the product price data, 3) product availability information for the at least one electronic product displayed in the at least one physical retail store, wherein the product availability information is based, at least in part, on the product inventory data of a particular physical retail store where the at least one electronic product is displayed, 4) content data related to the at least one electronic product, wherein the content data is dynamically generated from non-specification information of the at least one electronic product displayed in the at least one physical retail store, wherein the content data is associated with the at least one electronic product based, at least in part, on the product specification data of the at least one electronic product, 5) at least one recommendation to buy at least one other product sold by the at least one physical retail store, wherein the at least one recommendation is based, at least in part, on the product inventory data of the at least one physical retail store, 6) at least one tool which allows a customer to electronically perform at least one of the following action: i) view the content data related to the at least one electronic product, ii) place an order to purchase at least one product offered by the at least one physical retail store, iii) share with at least one other person at least a portion of the information provided by the on-screen layout, and iv) access information located outside of the at least one physical retail store, and 7) at least one code that can be electronically communicated from the on-screen layout of the at least one electronic product displayed in the at least one physical retail store to an electronic device of the customer located in the at least one physical retail store, wherein the electronic device of the customer uses the at least one code to electronically obtain at least a portion of the information provided by the on-screen layout; c) receiving, by a computer system, at least one input corresponding to the customer's interaction with the on-screen layout of the at least one electronic product displayed in the at least one physical retail store; and d) dynamically modifying, by a computer system, in response to the at least one input corresponding to the customer's interaction with the on-screen layout of the at least one electronic product displayed in the at least one physical retail store, at least one of the following: 1) the data in the at least one product database of electronic products sold in at least one physical retail store, 2) the on-screen layout of the at least one electronic product displayed in the at least one physical retail store, and 3) the at least a portion of the information provided by the on-screen layout in the electronic device of the customer.

In some embodiments, the at least one code is electronically communicated from the on-screen layout of the at least one electronic product displayed in the at least one physical retail store to the electronic device of the customer located in the at least one physical retail store, when the electronic device of the customer electronically acquires an image of the at least one code.

In some embodiments, the image represents a UPC code or a QR code.

In some embodiments, the at least one code is electronically communicated from the on-screen layout of the at least one electronic product displayed in the at least one physical retail store to the electronic device of the customer located in the at least one physical retail store, when the electronic device of the customer wirelessly acquires a data encoded by the at least one code from the at least one electronic product displaying the on-screen layout.

In some embodiments, the at least one recommendation to buy at least one other product sold by the at least one physical retail store is dynamically generated, by a computer system, based at least in part, on: 1) at least one assigned criteria, and 2) statistically applicable products.

In some embodiments, the at least one recommended product is at least one extended warranty offer.

In some embodiments, the product availability information for the at least one electronic product displayed in the at least one physical retail store is electronically updated based on a geographical location of the particular physical retail store.

In some embodiments, the content data comprising at least one of the following: 1) warranty information, 2) at least one product review, and 3) educational information.

In some embodiments, the on-screen layout is divided into tabs.

In some embodiments, the instant invention includes a computer system for operating products in a physical retail store which includes: i) memory having at least one region for storing computer executable program code; and ii) a processor for executing the program code stored in the memory, wherein the program code comprising: a) software code to provide at least one product database of electronic products sold in at least one physical retail store, wherein the at least one product database stores data comprising: 1) product specification data, 2) product price data, and 3) product inventory data; b) software code to dynamically generate an on-screen layout for at least one electronic product displayed in the at least one physical retail store, wherein the on-screen layout, comprising: 1) at least a portion of the product specification data for the at least one electronic product displayed in the at least one physical retail store, 2) a price for the at least one electronic product displayed in the at least one physical retail store, wherein the price is based, at least in part, on the product price data, 3) product availability information for the at least one electronic product displayed in the at least one physical retail store, wherein the product availability information is based, at least in part, on the product inventory data of a particular physical retail store where the at least one electronic product is displayed, 4) content data related to the at least one electronic product, wherein the content data is dynamically generated from non-specification information of the at least one electronic product displayed in the at least one physical retail store, wherein the content data is associated with the at least one electronic product based, at least in part, on the product specification data of the at least one electronic product, 5) at least one recommendation to buy at least one other product sold by the at least one physical retail store, wherein the at least one recommendation is based, at least in part, on the product inventory data of the at least one physical retail store, 6) at least one tool which allows a customer to electronically perform at least one of the following action: i) view the content data related to the at least one electronic product, ii) place an order to purchase at least one product offered by the at least one physical retail store, iii) share with at least one other person at least a portion of the information provided by the on-screen layout, and iv) access information located outside of the at least one physical retail store; and 7) at least one code that can be electronically communicated from the on-screen layout of the at least one electronic product displayed in the at least one physical retail store to an electronic device of the customer located in the at least one physical retail store, wherein the electronic device of the customer uses the at least one code to electronically obtain at least a portion of the information provided by the on-screen layout; c) software code to receive at least one input corresponding to the customer's interaction with the on-screen layout of the at least one electronic product displayed in the at least one physical retail store; and d) software code to dynamically modify, in response to the at least one input corresponding to the customer's interaction with the on-screen layout of the at least one electronic product displayed in the at least one physical retail store, at least one of the following: 1) the data in the at least one product database of electronic products sold in at least one physical retail store, 2) the on-screen layout of the at least one electronic product displayed in the at least one physical retail store, and 3) the at least a portion of the information provided by the on-screen layout in the electronic device of the customer.

In some embodiments, the inventive computer system and methods may instruct each electronic device, a station, of a pending playback. In some embodiments, the inventive computer system and methods may send the playback instruction within 10 seconds of the actual playback time. In some embodiments, the playback instruction to each of the electronic device may define a start time for the synchronized playback while addressing location specific content as well within a pre-defined “total loop” time (e.g. the playback instruction may be customized for each electronic device.)

In some embodiments, playback instructions may be configured as follows. Table 1 provides an example of one embodiment of the invention which may provide tailored instruction to three (3) electronic devices/products in the store. In the example, 00:00 is starting point of the synch content in a 2 minute “total loop.”

In some embodiments, synchronized content plays at 00:00, 00:10, and 00:25, then location specific content, with a total playback time of 1 minute, is played back. This loop repeats on it's synchronized schedule as shown in Table 1.

TABLE 1

| PRODUCT 1 | | PRODUCT 2 | | PRODUCT 3 | |
|---|---|---|---|---|---|
| 0:00 | Global Content | 0:00 | Global Content | 0:00 | Global Content |
| | Clip 1 (:10) | | Clip 1 (:10) | | Clip 1 (:10) |
| 0:10 | Global Content | 0:10 | Global Content | 0:10 | Global Content |
| | Clip 2 (:15) | | Clip 2 (:15) | | Clip 2 (:15) |
| 0:25 | Global Content | 0:25 | Global Content | 0:25 | Global Content |
| | Clip 3 (:35) | | Clip 3 (:35) | | Clip 3 (:35) |
| 1:00 | Local Content | 1:00 | Local Content | 1:00 | Local Content |
| | Clip 1 (:15) | | Clip 1 (:10) | | Clip 1 (:30) |
| 1:15 | Local Content | 1:10 | Local Content | 1:30 | Product Specific |
| | Clip 2 (:15) | | Clip 2 (:10) | | Flash Data (:30) |
| 1:30 | Product | 1:20 | Local Content | 2:00 | END OF LOOP |
| | Specific Flash | | Clip 3 (:10) | | |
| | Data (:30) | | | | |
| 2:00 | END OF | 1:30 | Product | | |
| | LOOP | | Specific Flash | | |
| | | | Data (:30) | | |
| | | 2:00 | END OF | | |
| | | | LOOP | | |

In some embodiments, the synchronized content “start time” would be executed by all three electronic devices/stations which are currently in “idle” mode (without human interaction). In some embodiments, if the station is mid-playback of other content, it will be terminated and the synchronized content will begin to play.

In some embodiments, this feature can be used to provide multi-device/station playback (definable region of display area) or entire department, or store.

In some embodiments, the location specific content includes real-time information which is location and station specific, accessed from the cloud via store location identifiers. In some embodiments, this real time data includes product specific pricing, inventory, content, manuals and/or other information as appropriate for the specific item.

In some embodiments, the local or individualized content may be determined by shoppers. In some embodiments, the inventive computer system and methods may instruct a plurality of electronic device/stations, that surround/flank the specific electronic device for which the localized/custom content is addressed, to play the same localized/custom content.

While a number of embodiments of the present invention have been described, it is understood that these embodiments are illustrative only, and not restrictive, and that many modifications may become apparent to those of ordinary skill in the art. For example, certain methods may have been described herein as being “computer implementable” or “computer implemented”. In this regard, it is noted that while such methods can be implemented using a computer, the methods do not necessarily have to be implemented using a computer. Also, to the extent that such methods are implemented using a computer, not every step must necessarily be implemented using a computer. Further still, the various steps may be carried out in any desired order (and any desired steps may be added and/or any desired steps may be eliminated).

While a number of embodiments of the present invention have been described, it is understood that these embodiments are illustrative only, and not restrictive, and that many modifications may become apparent to those of ordinary skill in the art. For example, certain methods may be “computer implementable” or “computer implemented.” In this regard, it is noted that while such methods can be implemented using a computer; the methods do not necessarily have to be implemented using a computer. Also, to the extent that such methods are implemented using a computer, not every step must necessarily be implemented using a computer. Further, any steps described herein may be carried out in any desired order (and any steps may be added and/or deleted).

What is claimed is:

1. A computer-implemented method, comprising
a) providing, by a computer system, at least one product database of products sold in at least one physical retail store, wherein the at least one product database stores data comprising:
1) product specification data,
2) product price data, and
3) product inventory data;
b) dynamically generating, by a computer system, an on-screen layout for at least one electronic product displayed in the at least one physical retail store, wherein the on-screen layout, comprising:
1) at least a portion of the product specification data for the at least one electronic product displayed in the at least one physical retail store,
2) a price for the at least one electronic product displayed in the at least one physical retail store, wherein the price is based, at least in part, on the product price data,
3) product availability information for the at least one electronic product displayed in the at least one physical retail store, wherein the product availability information is based, at least in part, on the product inventory data of a particular physical retail store where the at least one electronic product is displayed,
4) content data related to the at least one electronic product, wherein the content data is dynamically generated from non-specification information of the at least one electronic product displayed in the at least one physical retail store, wherein the content data is associated with the at least one electronic product based, at least in part, on the product specification data of the at least one electronic product,
5) at least one recommendation to buy at least one other product sold by the at least one physical retail store, wherein the at least one recommendation is based, at least in part, on the product inventory data of the at least one physical retail store,
6) at least one tool which allows a customer to electronically perform at least one of the following action:
i) view the content data related to the at least one electronic product;
ii) place an order to purchase at least one product offered by the at least one physical retail store,
iii) share with at least one other person at least a portion of the information provided by the on-screen layout, and
iv) access information located outside of the at least one physical retail store; and
7) at least one code that can be electronically communicated from the on-screen layout of the at least one electronic product displayed in the at least one physical retail store to an electronic device of the customer located in the at least one physical retail store, wherein the electronic device of the customer uses the at least one code to electronically obtain at least a portion of the information provided by the on-screen layout;
c) receiving, by a computer system, at least one input corresponding to the customer's interaction with the on-screen layout of the at least one electronic product displayed in the at least one physical retail store; and
d) dynamically modifying, by a computer system, in response to the at least one input corresponding to the customer's interaction with the on-screen layout of the at least one electronic product displayed in the at least one physical retail store, at least one of the following:
1) the data in the at least one product database of electronic products sold in at least one physical retail store,
2) the on-screen layout of the at least one electronic product displayed in the at least one physical retail store, and
3) the at least a portion of the information provided by the on-screen layout in the electronic device of the customer.

2. The method of claim 1, wherein the at least one code is electronically communicated from the on-screen layout of the at least one electronic product displayed in the at least one physical retail store to the electronic device of the customer located in the at least one physical retail store, when the electronic device of the customer electronically acquires an image of the at least one code.

3. The method of claim 2, wherein the image represents a UPC code or a QR code.

4. The method of claim 1, wherein the at least one code is electronically communicated from the on-screen layout of the at least one electronic product displayed in the at least one physical retail store to the electronic device of the customer located in the at least one physical retail store, when the electronic device of the customer wirelessly acquires a data encoded by the at least one code from the at least one electronic product displaying the on-screen layout.

5. The method of claim 1, wherein the at least one recommendation to buy at least one other product sold by the at least one physical retail store is dynamically generated, by a computer system, based at least in part, on:
1) at least one assigned criteria, and
2) statistically applicable products.

6. The method of claim 1, wherein the at least one recommended product is at least one extended warranty offer.

7. The method of claim 1, wherein the product availability information for the at least one electronic product displayed in the at least one physical retail store is electronically updated based on a geographical location of the particular physical retail store.

8. The method of claim 1, wherein the content data comprising at least one of the following:
1) warranty information,
2) at least one product review, and
3) educational information.

9. The method of claim 1, wherein the on-screen layout is divided into tabs.

10. A computer system for operating electronic products in a physical retail store, comprising
i) memory having at least one region for storing computer executable program code; and
ii) a processor for executing the program code stored in the memory, wherein the program code comprising:
a) software code to provide at least one product database of products sold in at least one physical retail store, wherein the at least one product database stores data comprising:
1) product specification data,
2) product price data, and
3) product inventory data;
b) software code to dynamically generate an on-screen layout for at least one electronic product displayed in the at least one physical retail store, wherein the on-screen layout, comprising:
1) at least a portion of the product specification data for the at least one electronic product displayed in the at least one physical retail store,
2) a price for the at least one electronic product displayed in the at least one physical retail store, wherein the price is based, at least in part, on the product price data,
3) product availability information for the at least one electronic product displayed in the at least one physical retail store, wherein the product availability information is based, at least in part, on the product inventory data of a particular physical retail store where the at least one electronic product is displayed,
4) content data related to the at least one electronic product, wherein the content data is dynamically generated from non-specification information of the at least one electronic product displayed in the at least one physical retail store, wherein the content data is associated with the at least one electronic product based, at least in part, on the product specification data of the at least one electronic product,
5) at least one recommendation to buy at least one other product sold by the at least one physical retail store, wherein the at least one recommendation is based, at least in part, on the product inventory data of the at least one physical retail store,
6) at least one tool which allows a customer to electronically perform at least one of the following action:
i) view the content data related to the at least one electronic product;
ii) place an order to purchase at least one product offered by the at least one physical retail store,
iii) share with at least one other person at least a portion of the information provided by the on-screen layout, and
iv) access information located outside of the at least one physical retail store; and
7) at least one code that can be electronically communicated from the on-screen layout of the at least one electronic product displayed in the at least one physical retail store to an electronic device of the customer located in the at least one physical retail store, wherein the electronic device of the customer uses the at least one code to electronically obtain at least a portion of the information provided by the on-screen layout;
c) software code to receive at least one input corresponding to the customer's interaction with the on-screen layout of the at least one electronic product displayed in the at least one physical retail store; and
d) software code to dynamically modify, in response to the at least one input corresponding to the customer's interaction with the on-screen layout of the at least one electronic product displayed in the at least one physical retail store, at least one of the following:
1) the data in the at least one product database of electronic products sold in at least one physical retail store,
2) the on-screen layout of the at least one electronic product displayed in the at least one physical retail store, and
3) the at least a portion of the information provided by the on-screen layout in the electronic device of the customer.

11. The system of claim 10, wherein the at least one code is electronically communicated from the on-screen layout of the at least one electronic product displayed in the at least one physical retail store to the electronic device of the customer located in the at least one physical retail store, when the electronic device of the customer electronically acquires an image of the at least one code.

12. The system of claim 11, wherein the image represents a UPC code or a QR code.

13. The system of claim 11, wherein the at least one code is electronically communicated from the on-screen layout of the at least one electronic product displayed in the at least one physical retail store to the electronic device of the customer located in the at least one physical retail store, when the electronic device of the customer wirelessly acquires a data encoded by the at least one code from the at least one electronic product displaying the on-screen layout.

14. The system of claim 10, wherein the at least one recommendation to buy at least one other product sold by the at least one physical retail store is dynamically generated, by a computer system, based at least in part, on:
1) at least one assigned criteria, and
2) statistically applicable products.

15. The system of claim 10, wherein the at least one recommended product is at least one extended warranty offer.

16. The system of claim 10, wherein the product availability information for the at least one electronic product displayed in the at least one physical retail store is electronically updated based on a geographical location of the particular physical retail store.

17. The system of claim 10, wherein the content data comprising at least one of the following:
1) warranty information,
2) at least one product review, and
3) educational information.

18. The system of claim 10, wherein the on-screen layout is divided into tabs.
